(19) United States
(12) Patent Application Publication
(10) Pub. No.: US 2005/0160670 A1
(43) Pub. Date: Jul. 28, 2005

(54) Convertible planter and fountain system

(76) Inventor: Jennifer Appel, Houston, TX (US)

Correspondence Address: LOCKE LIDDELL & SAPP LLP, 600 TRAVIS, 3400 CHASE TOWER, HOUSTON, TX, 77002-3095, US

(21) Appl. No.: 10/763,478

(22) Filed: Jan. 23, 2004

(51) Int. Cl. A01G 9/02

(52) U.S. Cl. 47/66.6

(57) ABSTRACT

The present invention includes a convertible planter and fountain system. The system can readily be converted between a planter and a fountain using the same container with removable elements to facilitate the conversion. The system also includes a hollow cavity formed between the exterior and interior portions of the container in which various elements can be mounted and concealed if desired. A pump provides water recirculation in the fountain mode through a water spout coupled to the pump.

### FIELD OF THE INVENTION

The invention relates to planters. More specifically, the invention relates to a convertible planter system that can be converted between a planter and a fountain.

### BACKGROUND OF THE INVENTION

Planters form an attractive and psychologically beneficial atmosphere in lobbies, dwellings, walkways, and other areas. Thus, architects carefully plan where and how to position planters in these areas. However, planters are sometimes inappropriate for a particular location. Low lighting or inadequate water sources for the foliage inhibit placement of planters, but the architect still may need some pleasing arrangement for that particular area. The architect may use framed art, statutes, and for an especially pleasing effect—a fountain.

It would be desirable if a particular planter was interchangeable with a fountain. Thus, early procurement could standardize an order for a given project, so that the architect would have flexibility in the final stages of the project to make changes without delaying the project.

Thus, there remains a need for an improved planter and fountain system that can be flexibly located and aesthetically appealing.

### SUMMARY OF THE INVENTION

The present invention provides a convertible planter and fountain system that can, flexibly use the same container in different configurations. In at least one embodiment, the container includes a hollow cavity formed so as to be accessible from an exterior portion of the container but sealed from an interior portion of the container. Various elements can be mounted in the hollow cavity and then concealed, if desired, so that the planter can resemble a typical planter and yet be relatively easily converted into a fountain.

The invention provides a convertible planter and fountain system, comprising a planter container adapted to retain soil and having a side and bottom; and a pump landing coupled to the container and having a surface disposed above the bottom, the pump landing forming a hollow cavity accessible from an exterior portion of the planter container and sealingly separated from an interior portion of the planter container.

The invention also provides a convertible planter and fountain system, comprising a planter container adapted to retain soil and having a side and bottom; a pump landing coupled to the container and having a surface disposed above the bottom, the pump landing forming a hollow cavity accessible from an exterior portion of the planter container and sealingly separated from an interior portion of the planter container; and a hollow channel formed on the interior portion of the container and extending in a vertical direction at least partially between the bottom and a top of the container.

The invention further provides a method of converting a convertible planter fountain between a water fountain and a planter, the planter fountain having a planter container adapted to retain soil and having a side and bottom; a pump landing coupled to the container, the pump landing forming a hollow cavity accessible from an exterior portion of the planter container and sealingly separated from an interior portion of the planter container; a pump coupled to the pump landing; a water fountain spout coupled to the pump and adapted to spray water from the pump above a water level in the planter container; and a valve mounted in the hollow cavity fluidicly coupled to the interior portion of the container, comprising draining at least a portion of any water contained in the container; removing the spout; and at least partially filling the container with soil.

### BRIEF DESCRIPTION OF THE DRAWINGS

A more particular description of the invention, briefly summarized above, can be realized by reference to the embodiments thereof that are illustrated in the appended drawings and described herein. However, it is to be noted that the appended drawings illustrate only some embodiments of the invention. Therefore, the drawings are not to be considered limiting of its scope, for the invention may admit to other equally effective embodiments.

FIG. 1 is a cross-sectional schematic side view of one embodiment of a convertible planter and fountain system.

FIG. 2 is a cross-sectional schematic side view of the convertible planter and fountain system of FIG. 1 in an exemplary fountain configuration.

FIG. 3 is a cross-sectional schematic side view of the convertible planter and fountain system of FIG. 1 in an exemplary planter configuration.

### DETAILED DESCRIPTION OF THE INVENTION

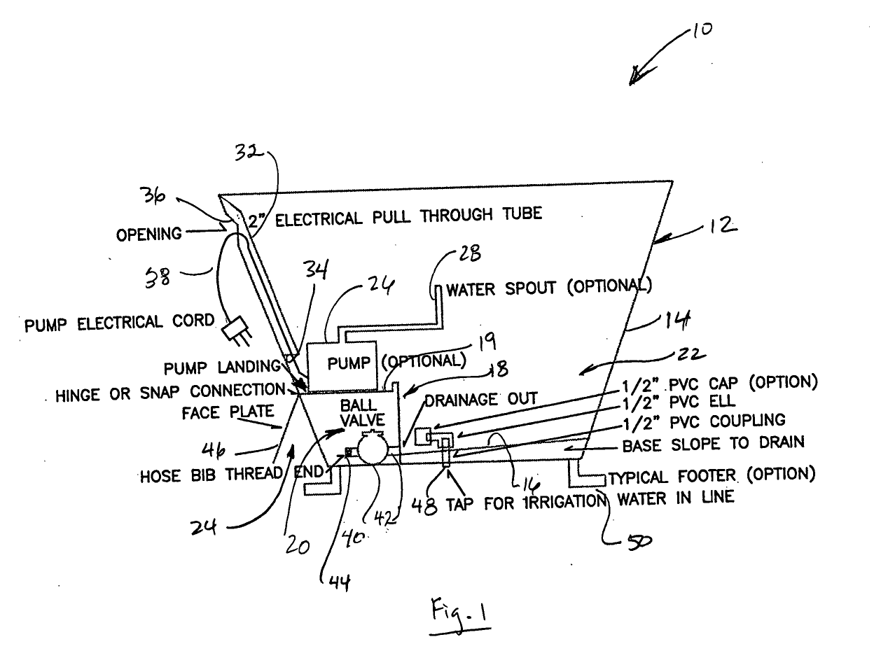

FIG. 1 is a cross-sectional schematic side view of one embodiment of a convertible planter and fountain system. An exemplary convertible planter and fountain system 10 includes a container 12 which can be converted between use as a fountain or a planter. In general, the container 12 includes one or more sides 14 and a bottom 16. The container 12 can have a variety of shapes and the particular shape shown is not limiting thereof. In at least one embodiment, the bottom 16 can be sloped to facilitate drainage through a valve, described below. Further, the container 12 can include supports 17, such as feet, castors, rails, and other supports, to elevate the container or more readily allow movement.

A pump landing 18 is coupled to the container 12. The term “coupled,” “coupling,” and like terms are used broadly herein and can include any method or device for securing, binding, bonding, fastening, attaching, joining, inserting therein, forming thereon or therein, communicating, or otherwise associating, for example, mechanically, fluidicly, magnetically, electrically, chemically, directly or indirectly with intermediate elements, one or more pieces of members together and can further include integrally forming one functional member with another. In some embodiments, the pump landing 18 can be formed integrally with the container 12 and in other embodiments, the pump landing can be attached after formation. The pump landing can have a variety of shapes and the embodiment shown is not limiting thereof.

In one embodiment the pump landing can be disposed between the side 14 and the bottom 16, although other locations are within the scope of the invention. The pump landing 18 can include a surface 19 that is disposed above the bottom. In at least one embodiment, the pump landing 18 forms a hollow cavity 20 that is accessible from an exterior portion of the container 12 and sealingly separated from the interior portion 22 of the container. The pump landing 18 and the cavity 20 formed therefrom provide a location for mounting various elements contained in the system 10. For example, a pump 26 can be mounted on the surface 19 or in close proximity therewith, or in the cavity 20, depending upon the desired arrangement of the particular embodiment. In some embodiments, the pump 26 can be a submersible pump suitable for mounting under water, although other types of pumps can be used.

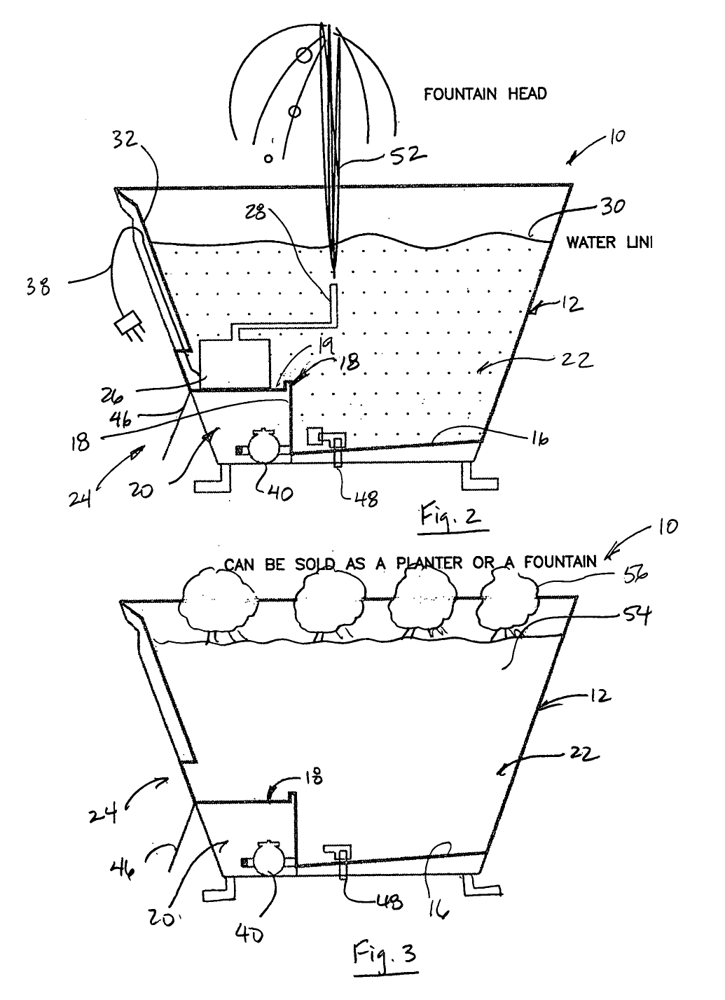

A spout 28 can be coupled to the pump 26. The spout 28 is used to spray water from the pump above a water level in the planter container, such as water level 30 shown in FIG. 2. The term “water” as used herein includes pure water or mixtures of water with other fluids. The spout 28 is generally removable from the pump.

A hollow channel 32 may be advantageously formed or otherwise coupled to the container 12. For example, the channel 32 can be vertical adjacent the side 14, having an opening 34 in communication with the interior portion 22 and an opening 36 in communication with the exterior portion 24. The term “vertical” is intended to be used broadly and is generally in a direction having a vertical compound greater than a horizontal component. Without limitation, the channel 32 can be used to provide a conduit for a power cord 38 from the pump 26. The opening 36 is generally advantageously disposed at an elevation higher than any anticipated water level in the container 12.

A valve 40 can be disposed in the cavity 20. The valve can have one port 42 fluidicly coupled to the interior portion 22 of the container 12. In at least one embodiment, the port 42 is disposed at or near the bottom 16 to facilitate drainage of water from the container 12. Another port 44 is accessible from the exterior portion 24 of the container. Further, the port 44 can be coupled to conduits, such as hoses, to facilitate the discharge of water through the valve 40 to a selected location (not shown).

Aesthetically, a face plate 46 can be coupled to the exterior portion 24 of the container 12. The face plate can be hinged, snapped, or otherwise coupled to the container and can conceal the elements mounted in the cavity 20.

A conduit 48 can also be disposed in the container 12 to provide an inlet or outlet for water in the container 12. For example, the conduit 48 can be coupled to a water line to allow water to flow therethrough into the container, and the valve 40 can be used to discharge water from the container.

If desired, the container 12 can include a footer 50 for elevating the container 12 from a supporting surface. The elevation can be useful if the conduit 48 is disposed through the bottom 16. A valve, not shown, can be coupled to the conduit 48 to control water flow into the container.

FIG. 2 is a cross-sectional schematic side view of the convertible planter and fountain system of FIG. 1 in an exemplary fountain configuration. FIG. 3 is a cross-sectional schematic side view of the convertible planter and fountain system of FIG. 1 in an exemplary planter configuration. FIGS. 2 and 3 will be described in conjunction with each other. Similar elements shown in FIG. 1 will be similarly labeled herein. The planter and fountain system 10 includes the container 12 on or in which various elements can be mounted. For example and without limitation, a pump landing 18 can be coupled to the container 12 to form the cavity 20 which can be concealed by a face plate 46, if desired. In at least one embodiment, the channel 32 can be coupled to the container 12 on the interior portion 22 for aesthetic reasons.

A pump 26 can be mounted to the pump landing 18, such as on the surface 19 or in the cavity 20. A spout 28, coupled to the pump 26, can be used to create a spray 52 of water contained in the interior portion 22 of the container 12 above a water level 30. Water can be provided to the container 12 through the conduit 48 coupled to the container 12. Alternatively, water can be provided to the container through the valve 40.

To convert the planter and fountain system 10 from a fountain to a planter, at least a portion of the water 30 in the container 12 can be drained from the container, such as through the valve 40 in the cavity 20. A sloped bottom 16 facilitates the drainage through the valve 40. Generally, the spout 28 will be removed from the container with or without the pump 26. In many instances, both pump and water spout will be removed. The container 12 can be at least partially filled with soil. The term “soil” as used herein includes any growing media that will support plant life. One or more plants 56 can be planted into the soil 54, so that the planter and fountain system 10 resembles a standard planter.

To convert the planter fountain, at least a portion of the soil 54 would be removed from the container 12. The pump can be installed, if not already present, and the spout 28 can be coupled to the pump. The container 12 can be filled at least partially with water to a desired level. The pump would then be activated to spray water through the spout to form the fountain.

Further, the container 12 can be used to support trays, racks, and other plant supports, such as in greenhouses and hot houses. The spray 52 can readily water the plants. An operator can transfer the plants as they reach sufficient maturity and insert other plants. Still further, a light (not shown) can be mounted in proximity to the container 12 to assist in growing the plants.

While the foregoing is directed to various embodiments of the present invention, other and further embodiments may be devised without departing from the basic scope thereof. Other embodiments within the scope of the claims herein will be apparent to one skilled in the art from consideration of the specification and practice of the invention as disclosed herein. For example, the pump could be mounted in alternative locations relative to the pump landing, the pump landing can be coupled to the container in various locations, and the system can include several pump landings and other variations. It is intended that the specification, together with the example, be considered exemplary only, with the scope and spirit of the invention being indicated by the claims that follow.

The various methods and embodiments of the invention can be included in combination with each other to produce variations of the disclosed methods and embodiments, as would be understood by those with ordinary skill in the art, given the understanding provided herein. Also, various aspects of the embodiments could be used in conjunction with each other to accomplish the understood goals of the invention. Also, the directions such as “top,” “bottom,” “left,” “right,” “upper,” “lower,” and other directions and orientations are described herein for clarity in reference to the figures and are not to be limiting of the actual device or system or use of the device or system. Unless the context requires otherwise, the word “comprise” or variations such as “comprises” or “comprising”, should be understood to imply the inclusion of at least the stated element or step or group of elements or steps or equivalents thereof, and not the exclusion of a greater numerical quantity or any other element or step or group of elements or steps or equivalents thereof. The device or system may be used in a number of directions and orientations. Further, the order of steps can occur in a variety of sequences unless otherwise specifically limited. The various steps described herein can be combined with other steps, interlineated with the stated steps, and/or split into multiple steps. Additionally, the headings herein are for the convenience of the reader and are not intended to limit the scope of the invention.

Further, any references mentioned in the application for this patent as well as all references listed in the information disclosure originally filed with the application are hereby incorporated by reference in their entirety to the extent such may be deemed essential to support the enabling of the invention. However, to the extent statements might be considered inconsistent with the patenting of the invention, such statements are expressly not meant to be considered as made by the Applicant.

1. A convertible planter and fountain system, comprising:
a. a planter container adapted to retain soil and having a side and bottom; and
b. a pump landing coupled to the container and having a ice disposed above the bottom, the pump landing forming a hollow cavity accessible from an exterior portion of the planter container and sealingly separated from an interior portion of the planter container.

2. The system of claim 1, further comprising a pump coupled to the pump landing.

3. The system of claim 2, further comprising a water fountain spout coupled to the pump and adapted to spray water from the pump above a water level in the planter container.

4. The system of claim 1, further comprising a hollow channel coupled to the side of the planter container.

5. The system of claim 4, further comprising a pump mounted to the pump landing and having a power cord extending through the channel to an exterior portion of the container.

6. The system of claim 1, further comprising a valve mounted in the hollow cavity and having one port fluidicly coupled to the interior portion of the container and another port accessible from the exterior portion of the container.

7. The system of claim 1, further comprising a conduit coupled to the container and adapted to supply water to the container.

8. A convertible planter and fountain system, comprising:
a. a planter container adapted to retain soil and having a side and bottom;
b. a pump landing coupled to the container and having a surface disposed above the bottom, the pump landing forming a hollow cavity accessible from an exterior portion of the planter container and sealingly separated from an interior portion of the planter container; and
c. a hollow channel formed on the interior portion of the container and extending in a vertical direction at least partially between the bottom and a top of the container.

9. The system of claim 8, further comprising a pump coupled to the pump landing.

10. The sync of claim 9, further comprising a water fountain spout coupled to the pump and adapted to spray water form the pump above a water level in the planter container.

11. The system of claim 8, further comprising a valve mounted in the hollow cavity and having one port fluidicly coupled to the interior portion of the container and another port accessible from the exterior portion of the container.

12. A method of converting the convertible planter and fountain system of claim 3 between a water fountain and a planter, comprising:
a. draining at least a portion of any water contained in the container;
b. removing the spout; and
c. at least partially filling the container with soil.

13. The method of claim 12, further comprising watering the soil with a pressurized water conduit sealingly engaged with the interior portion of the container.

14. The method of claim 12, further comprising converting the planter and fountain system into a fountain comprising;
a. removing at least a portion of the soil;
b. coupling the spout to the pump; and
c. at least partially filling the container with water.

15. The method of claim 14, further comprising activating the pump to spray water through the spout.

16. The method of claim 12, further comprising removing the pump from the container.
